(19) United States
(12) Patent Application Publication
(10) Pub. No.: US 2025/0133334 A1
(43) Pub. Date: Apr. 24, 2025

(54) SYSTEM FOR SOUND DIFFUSION

(71) Applicant: IXOOST S.R.L., Modena (IT)

(72) Inventor: Giovanni PANINI, Modena (IT)

(21) Appl. No.: 18/918,537

(22) Filed: Oct. 17, 2024

(30) Foreign Application Priority Data
Oct. 20, 2023 (IT) 102023000021948

(51) Int. Cl. H04R 1/34; H04R 1/02

(52) U.S. Cl. CPC H04R 1/345; H04R 1/028

(57) ABSTRACT

A system for sound diffusion, comprising at least one supporting structure, sound diffusion means associated with the supporting structure and adapted to diffuse sound waves and connection means associated with the diffusion means and adapted to be connected with a sound source unit, wherein the supporting structure comprises a protective helmet made in a single body piece and defining an open cavity,
wherein the diffusion means comprise at least one self-supporting closure body, inserted within the protective helmet so as to close the open cavity defining a substantially enclosed volume,
wherein the diffusion means comprise at least one loudspeaker device associated with the closure body and arranged within the enclosed volume; and
wherein the diffusion means comprise a diffusion duct housed within the enclosed volume and communicating with the outside through an outlet opening defined on the supporting structure

### TECHNICAL FIELD

The present invention relates to a system for sound diffusion, particularly for music diffusion.

### BACKGROUND ART

There are many known systems for sound diffusion, such as stereo, Hi-Fi or similar systems, which may have different technical characteristics as well as varying sizes.

In particular, the systems for sound diffusion known to date are made using components specifically designed for this purpose and specifically conceived to optimize sound quality and thus to reproduce music with high fidelity.

Such systems of known type generally consist of a supporting structure that defines a substantially closed cavity, sound diffusion means, such as e.g. loudspeakers, and connection means for connecting the diffusion means to a sound source unit.

The supporting structure generally consists of a case, parallelepiped in shape, within which the various components are placed. Specifically, the supporting structure has a front face, generally facing the users, on which the loudspeakers are placed, and a rear face, facing a wall, on which additional components such as e.g. the electrical connectors are placed. The systems of known type thus have a minimalist, very simple appearance that in some contexts, especially home ones, may be unappealing or at odds with the furniture.

In this sense, therefore, the industry of the systems for sound diffusion has been enriched in recent years with new solutions aimed at giving a special decorative property to the systems for sound diffusion.

In the case of reflex systems, i.e., systems provided with a reflex duct, the latter flows to one of the case walls through a relevant opening. This type of system takes advantage of the presence of the duct to allow the sound waves which are generated to the rear of the loudspeaker to exit. The presence of the reflex duct makes it possible to optimize sound diffusion but, at the same time, greatly constrains the geometry of the supporting structure and the appearance of the diffusion system.

### DESCRIPTION OF THE INVENTION

The main aim of the present invention is to devise a system for sound diffusion which allows for optimal diffusion of sound waves and at the same time has a valuable decorative effect.

Another object of the present invention is to devise a system for sound diffusion which allows the aforementioned drawbacks of the prior art to be overcome within the framework of a simple, rational, easy and effective to use, as well as affordable solution.

The aforementioned objects are achieved by this system for sound diffusion having the characteristics of claim 1.

### BRIEF DESCRIPTION OF THE DRAWINGS

Other characteristics and advantages of the present invention will become more apparent from the description of a preferred, but not exclusive, embodiment of a system for sound diffusion, illustrated by way of an indicative, yet non-limiting example in the accompanying tables of drawings in which:

FIG. 1 is an axonometric view of the system according to the invention;

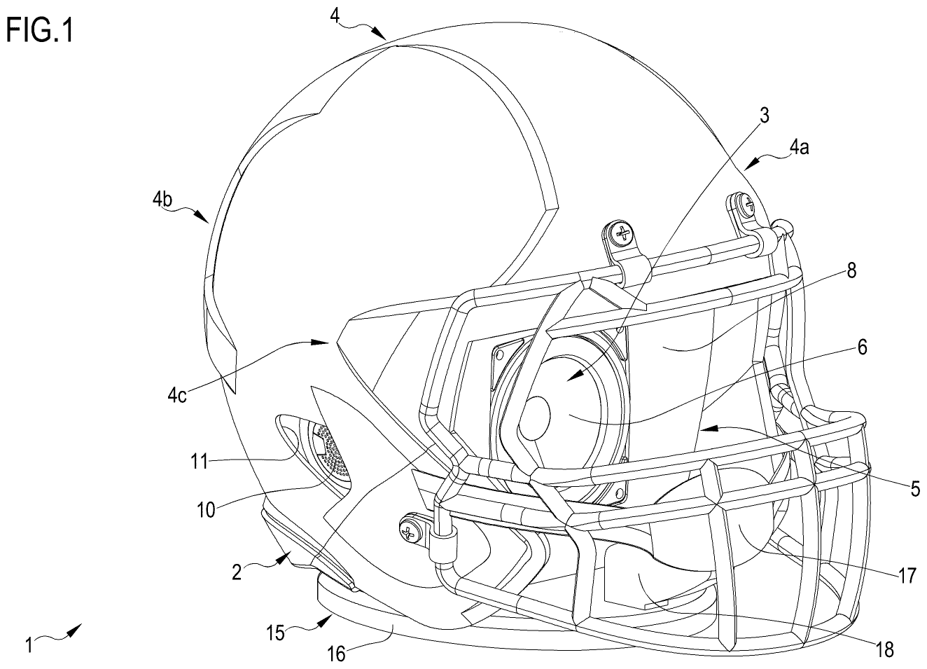

FIG. 2 is an exploded view of the system according to the invention;

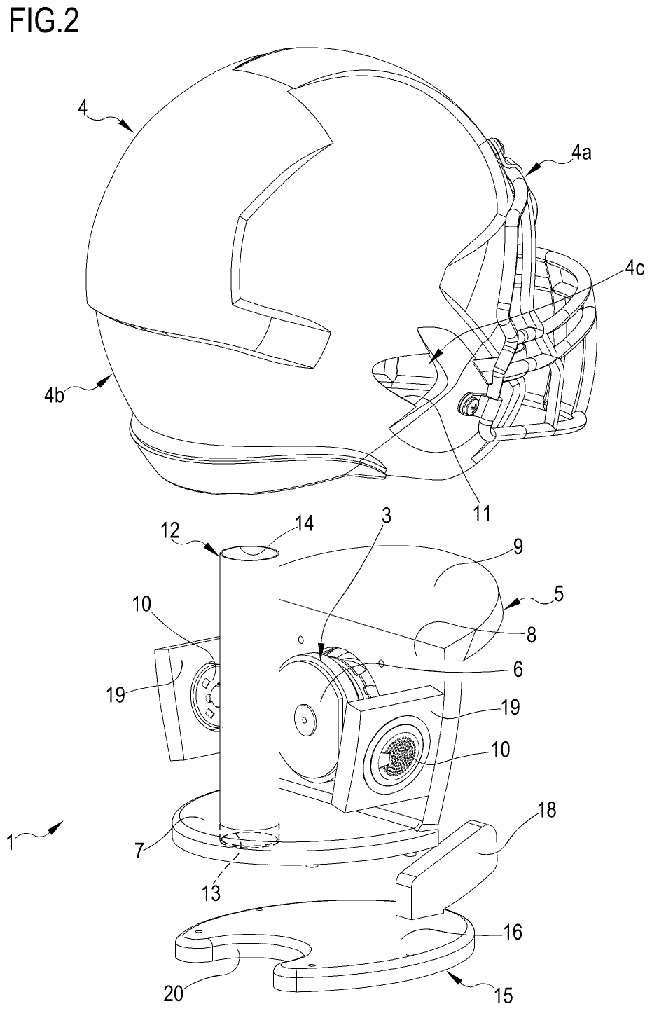

FIG. 3 is a side sectional view of the system according to the invention.

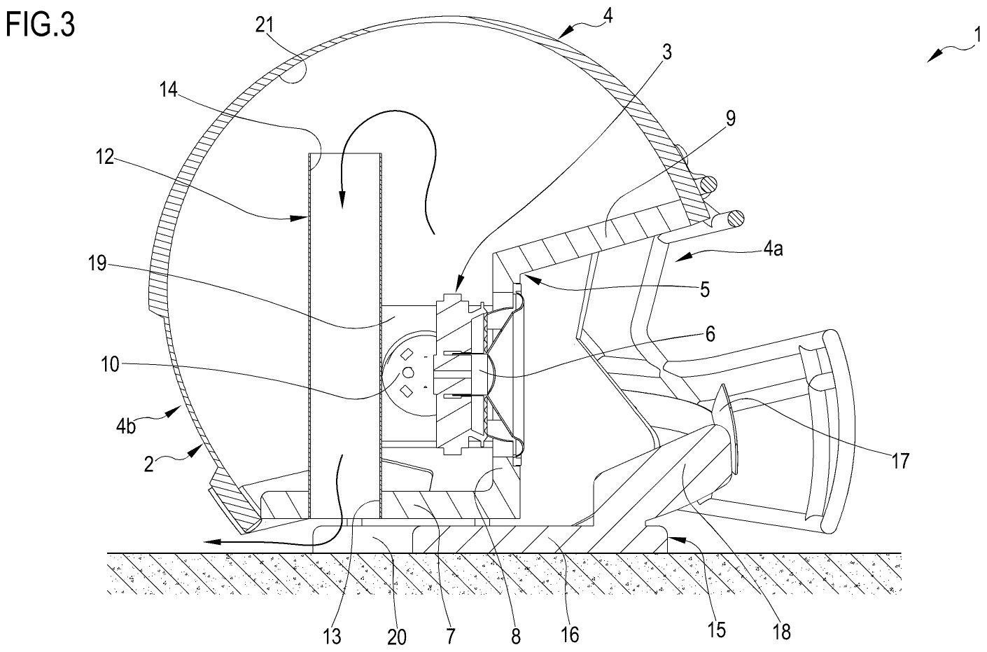

### EMBODIMENTS OF THE INVENTION

With particular reference to these figures, reference numeral 1 globally denotes a system for sound diffusion.

The system 1 comprises at least one supporting structure 2, sound diffusion means 3 associated with the supporting structure 2 and adapted to diffuse sound waves and connection means associated with the diffusion means 3 and adapted to be connected with a sound source unit.

The connection means are of the electrical type and are adapted to transfer the electrical signal emitted by the source unit to the diffusion means 3 which, as known, are then adapted to convert such an electrical signal into sound.

In accordance with the preferred embodiment, the source unit is of the type of a remote device, e.g. the type of a telephone, smartphone, music player or any electronic device adapted to store and transmit music tracks or sound files.

Thus, in this case, the connection means comprise connector members, not shown in detail in the figures, associated with the supporting structure 2 to enable a physical connection to the source unit.

In combination or as an alternative thereof, the connection means may comprise a remote connection device, of the radio wave type.

In an alternative embodiment, which is not shown in the figures, the source unit can be integrated with the system 1 and then locked together with the supporting structure 2, such as e.g. a CD/MP3 player. In this case, the connection means are directly connected to the source unit itself.

According to the invention, the supporting structure 2 comprises a protective helmet 4 made as a single body piece and defining an open cavity. And the diffusion means 3 comprise at least one closure body 5 associated with the protective helmet 4 so as to close the open cavity by defining a substantially enclosed volume 21 and comprise at least one loudspeaker device 6, 10 supported by the closure body 5 and arranged within the enclosed volume 21. The closure body 5 is of the self-supporting type, i.e., it does not require additional holding elements and independently supports the loudspeaker device 6, 10.

In the context of this disclosure, the term “protective helmet” relates to a protective device generally used in sports and/or leisure and intended to protect a person's head. The protective helmet 4 can be selected from, e.g., a football helmet, motorcycle helmet, motor racing helmet, rugby helmet, field hockey helmet, baseball helmet, etc. In addition, the protective helmet 4 can be of the full-face type, i.e., configured to cover part of the face as well, or of the open-face type, i.e., configured to leave the face free. In the latter case, the protective helmet 4 may comprise a grating front member. In accordance with the embodiment shown in the figures, a football helmet is shown as an example.

The protective helmet 4 has a front portion 4a, a rear portion 4b, opposite the front portion 4a, and two side portions 4c. In the traditional use of the protective helmet 4, its front portion 4a is the one arranged where the user's forehead is located, the rear portion 4b is intended to cover the nape of the neck and the side portions 4c are arranged where the ears are located. Appropriately, each of the side portions 4c is provided with a corresponding side opening 11. Specifically, the side openings 11 are those designed to allow hearing while wearing protective helmets.

As anticipated above, the protective helmet 4 and, in particular, its part defining the open cavity intended, in its original function, to accommodate the user's head, is made as a single body piece.

In actual facts, the enclosed structure of this system 1 is defined by a protective helmet 4, which is known to have a partly spherical conformation, and by the closure body 5 which, when applied to the protective helmet 4, results in the formation of an internal cavity.

The use of a protective helmet 4 makes it possible to give a valuable aesthetic and decorative effect to the system 1 which can then be used as a decorative item in home settings as well.

It should also be specified that the expression “substantially closed” relates to the fact that the cavity is completely enclosed with the exception of the necessary openings designed for the escape of sound waves, i.e., the openings defined by the diffusion means 3. In other words, the protective helmet 4 and the closure body 5 are devoid of openings other than those necessary for the operation of the diffusion means 3.

Furthermore, the terminology “the diffusion means 3 [ . . . ] comprise at least one loudspeaker device 6, 10 supported by the closure body 5 and arranged within the enclosed volume 21” means that the loudspeaker device 6, 10 is associated with the closure body 5 and protrudes within the enclosed volume 21. Since the loudspeaker device 6, 10 is adapted to diffuse the sound waves outwards, it may be visible or accessible from the outside.

The closure body 5 comprises at least one substantially horizontal lower wall 7 and intended to face a resting surface of the system 1.

The lower wall 7 is placed in contact with the base of the protective helmet 4.

The lower wall 7 is substantially planar; it cannot, however, be ruled out that the lower wall 7 may be curved or have another different conformation.

The closure body 5 also comprises a substantially vertical front wall 8 and arranged where the front portion 4a is located. The front wall 8 is thus intended, in use (i.e., during the use of system 1), to face a user.

The front wall 8 is contiguous with the lower wall 7 and is placed substantially perpendicular thereto.

In this context, it is also specified that the expression “substantially vertical” relates to the fact that the front wall may lie on a plane which is substantially vertical or inclined with respect to verticality depending on the conformation of the protective helmet 4 and/or the direction to be imparted to the sound waves generated by the loudspeaker device 6.

Also, in accordance with the embodiment shown in the figures, the front wall 8 is substantially planar although it cannot be ruled out that the front wall 8 may be curved or have another different conformation.

The system 1 is also provided with a cover element, not shown in detail in the figures, and adapted to cover the front wall 8. For example, the cover element is of the type of a sponge layer.

Appropriately, the closure body 5 also comprises two side walls 19, which are arranged where the side openings 11 are located. The side walls 19 are arranged substantially orthogonal to the lower wall 7 and to the front wall 8. In the specific embodiment shown in the figures, the side walls 19 extend from the front wall 8 and are spaced apart from the lower wall 7.

The loudspeaker device 6, 10 comprises at least one main loudspeaker 6 associated with the front wall 8.

In accordance with the preferred embodiment, the main loudspeaker 6 is a woofer.

The woofer is a type of loudspeaker designed to reproduce the low frequencies of the audio range, that is, those below 250 Hz.

In accordance with the embodiment shown in the figures, the closure body 5 also comprises an upper wall 9 substantially contiguous with and transverse to the front wall 8. The upper wall 9 contributes to the closure of the top of the cavity defined by the protective helmet 4. It cannot be ruled out that, depending on the conformation of the protective helmet 4, the closure body 5 may lack the upper wall 9.

Preferably, the loudspeaker device 6, 10 also comprises at least one secondary loudspeaker 10 of a different type from the main loudspeaker 6.

More specifically, the secondary loudspeaker 10 is a tweeter.

The tweeter, on the other hand, is a type of loudspeaker designed to reproduce the high frequencies of the audio range, that is, those up to 100 KHz.

Conveniently, the diffusion means 3 comprise two secondary loudspeakers 10. The secondary loudspeakers 10 are associated with the protective helmet 4 where the side openings 11 with which it is provided are located.

In detail, each of the secondary loudspeakers 10 is supported by a relevant side wall 19.

Advantageously, the main loudspeaker 6 and the secondary loudspeakers 10 are arranged with each other at the same height with respect to the lower wall 7. This allows for optimal sound diffusion.

It cannot, however, be ruled out that the diffusion means 3 may comprise one or more loudspeakers of different type.

Still in accordance with the invention, the diffusion means 3 comprise a diffusion duct 12 housed within the enclosed volume 21 and communicating with the outside through an outlet opening 13 defined on the supporting structure itself.

The diffusion duct 12 is of tubular conformation and is of the type of a reflex duct. The function of the diffusion duct 12 is to allow the sound waves to exit, through the outlet opening 13, which waves are generated by the loudspeaker device 6, 10 posteriorly thereto, that is, within the supporting structure 2.

Advantageously, the diffusion duct 12 is arranged at least partly posteriorly to the main loudspeaker 6.

In detail, the diffusion duct 12 also comprises an inlet opening 14 opposite the outlet opening 13 and adapted to receive the sound waves and to convey them towards the latter opening.

The inlet opening 14 is arranged within the supporting structure 2 where the main loudspeaker 6 is located.

Conveniently, the outlet opening 13 is defined on the closure body 5.

In this way, the structure of the protective helmet 4 is preserved so that the decorative character thereof is not altered.

It cannot, however, be ruled out that the opening may be defined on the protective helmet 4.

In accordance with the embodiment shown in the figures, the diffusion duct 12 runs along a substantially vertical direction.

Advantageously, the outlet opening 13 is defined on the lower wall 7 and is placed where the rear portion 4b of the protective helmet 4 is located, thus in a position opposite the main loudspeaker 6. This allows optimizing the fluid dynamics of the sound waves produced by the main loudspeaker 6, thus allowing optimal sound diffusion.

Also, in this way, during use, the outlet opening 13 is not visible from the outside.

It cannot be ruled out that the diffusion duct 12 may have a different arrangement and that the outlet opening 13 may be defined on another of the walls of the closure body 5, e.g. on the front wall 8.

Conveniently, the system 1 also comprises lifting means 15 associated with the supporting structure 2 and adapted to keep the lower wall 7 raised above the resting surface.

By doing so, the outlet opening 13 is not immediately in contact with the resting surface and the output of sound waves is facilitated.

The lifting means 15 comprise a base 16 positionable on the resting surface, of substantially planar conformation, arranged inferiorly to the lower wall 7 and comprising a recess 20 where the outlet opening 13 is located.

In accordance with the embodiment shown in the figures, the protective helmet 4 is further provided with a chin protection device 17. In this case, the supporting structure 2 also comprises a holding member 18 adapted to hold the chin protection device 17. In this case, the holding member 18 is associated with the base 16.

It has in practice been ascertained that the described invention achieves the intended objects, and in particular, the fact is emphasized that the system for sound diffusion according to the invention allows for optimal diffusion of sound waves and at the same time has a valuable decorative effect.

In particular, the mutual positioning of the main loudspeaker and of the outlet opening allow for optimized sound diffusion.

Again, the coupling between the protective helmet, made in a single body piece, and the closure body supporting the loudspeaker device, allow for easy and practical assembly of the parts, optimal mutual arrangement of the various components and a fine aesthetic appearance.

1) A system for sound diffusion, comprising at least one supporting structure, sound diffusion means associated with said supporting structure and adapted to diffuse sound waves and connection means associated with said diffusion means and adapted to be connected with a sound source unit, characterized by the fact that said supporting structure comprises a protective helmet made in a single body piece and defining an open cavity,
wherein said diffusion means comprise at least one self-supporting closure body, inserted within said protective helmet so as to close said open cavity defining a substantially enclosed volume,
wherein said diffusion means comprise at least one loudspeaker device associated with said closure body and arranged within said enclosed volume; and
wherein said diffusion means comprise a diffusion duct housed within said enclosed volume and communicating with the outside through an outlet opening defined on said supporting structure.

2) The system according to claim 1, wherein said outlet opening is defined on said closure body.

3) The system according to claim 2, wherein said closure body comprises at least one substantially horizontal lower wall and intended to face a resting surface of said system and wherein said diffusion duct runs along a substantially vertical direction, said outlet opening being defined on said lower wall.

4) The system according to claim 3, wherein the system comprises lifting means associated with said supporting structure and adapted to keep said lower wall raised above said resting surface.

5) The system according to claim 1, wherein said protective helmet has a front portion, intended to face a user, and a rear portion opposite the front portion, by the fact that said closure body comprises a substantially vertical front wall and arranged where said front portion is located, wherein said loudspeaker device comprises at least one main loudspeaker associated with said front wall, and wherein said outlet opening is arranged where said rear portion of said protective helmet is located.

6) The system according to claim 5, wherein said main loudspeaker is a woofer.

7) The system according to claim 1,
wherein said protective helmet has a front portion, intended to face a user, and a rear portion opposite the front portion,
wherein said closure body comprises a substantially vertical front wall and arranged wherein said front portion is located, wherein said loudspeaker device comprises at least one main loudspeaker associated with said front wall,
wherein said closure body comprises at least one substantially horizontal lower wall and contiguous to said front wall, and intended to face a resting surface of said system, wherein said diffusion duct runs along a substantially vertical direction, said outlet opening being defined on said lower wall and being arranged where said rear portion of said protective helmet is located.

8) The system according to claim 7, wherein said main loudspeaker is a woofer.

9) The system according to claim 1, wherein said loudspeaker device comprises at least one main loudspeaker and at least one secondary loudspeaker different from said main loudspeaker.

10) The system according to claim 9, wherein said secondary loudspeaker is a tweeter.

11) The system according to claim 9, wherein said diffusion means comprise two of said secondary loudspeakers and wherein said secondary loudspeakers are associated with said protective helmet where the side openings with which said protective helmet is provided are located.

12) The system according to claim 11, wherein said main loudspeaker and said secondary loudspeakers are arranged at the same height.

13) The system according to claim 11, wherein said closure body comprises at least two side walls arranged substantially orthogonal to said front wall and to said lower wall and wherein said secondary loudspeakers are supported by said side walls.

14) The system according to claim 13, wherein said side walls extend from said front wall and are spaced apart from said lower wall.
